(19) United States
(12) Patent Application Publication
(10) Pub. No.: US 2018/0217558 A1
(43) Pub. Date: Aug. 2, 2018

(54) TIMEPIECE PART AND TIMEPIECE

(71) Applicant: Seiko Epson Corporation, Tokyo (JP)

(72) Inventor: Daiki FURUSATO, Ina (JP)

(21) Appl. No.: 15/879,528

(22) Filed: Jan. 25, 2018

(30) Foreign Application Priority Data
Jan. 30, 2017 (JP) 2017-014556
Nov. 9, 2017 (JP) 2017-216499

(51) Int. Cl. G04B 37/00; G04B 37/12

(52) U.S. Cl. CPC G04B 37/0008; G04B 37/084; G04B 37/12

(57) ABSTRACT

A timepiece part includes a metallic luster portion which has a first region constituted of a first material including a nitride or carbide of Ti, a nitride or carbide of Cr, or a metallic material, a film-like second region constituted of a second material including a nitride or carbide of Ti, a nitride or carbide of Cr, or a metallic material, and a film-like third region which is provided between the first region and the second region and is constituted of a light transmissive material and which exhibits metallic luster and a tone film which is provided on the second region side of the metallic luster portion, is constituted of a multilayer film of a metallic oxide, and has a function of adjusting tone.

### BACKGROUND

### 1. Technical Field

The present invention relates to a timepiece part and a timepiece.

### 2. Related Art

Timepieces are required to have functions as a practical product and are also required to have excellent aestheticity (aesthetic appearance) as a decorative product.

Therefore, for a timepiece part such as dials and cases, noble metal materials having excellent texture are being used (for example, refer to JP-A-2009-69078).

However, noble metal materials are generally expensive, and there is a demand for suppressing excess use in consideration of reserves and the like.

### SUMMARY

An advantage of some aspects of the invention is to provide a timepiece part having an excellent appearance even without using noble metal as a main material and provide a timepiece including the timepiece part.

The advantage can be achieved by the following configurations.

A timepiece part according to an aspect of the invention includes a metallic luster portion which has a first region constituted of a first material including a nitride or carbide of Ti, a nitride or carbide of Cr, or a metallic material, a film-like second region constituted of a second material including a nitride or carbide of Ti, a nitride or carbide of Cr, or a metallic material, and a film-like third region which is provided between the first region and the second region and is constituted of a light transmissive material and which exhibits metallic luster and a tone film which is provided on the second region side of the metallic luster portion, is constituted of a multilayer film of a metallic oxide, and has a function of adjusting tone.

With this configuration, it is possible to provide a timepiece part having an excellent appearance without using noble metal as a main material.

In the timepiece part according to the aspect of the invention, it is preferable that the first region is a base material constituted of the first material.

With this configuration, it is possible to make the structure of the timepiece part simpler and improve the productivity of the timepiece part.

In the timepiece part according to the aspect of the invention, it is preferable that the first region is a coating provided on a base material constituted of a material not substantially including any of a nitride and a carbide of Ti, a nitride and a carbide of Cr, and a metallic material.

With this configuration, it is possible to broaden the range of choice of the constituent material and the like of the base material and broaden the range of choice of the molding method of the timepiece part, the range of choice of the disposition portion of the timepiece part in timepieces, and the like. In addition, it is possible to decrease the amount of the metallic materials used for the entire timepiece part.

In the timepiece part according to the aspect of the invention, it is preferable that the first region has a thickness of 10 nm or more.

With this configuration, it is possible to improve the luster feeling and aestheticity of the entire timepiece part.

In the timepiece part according to the aspect of the invention, it is preferable that the second region has a thickness of 200 nm or less.

With this configuration, it is possible to improve the luster feeling and aestheticity of the entire timepiece part. In addition, the angle dependency of the appearance of the timepiece part decreases, and excellent aestheticity can be stably obtained at broader view angles.

In the timepiece part according to the aspect of the constituted of a metallic oxide.

With this configuration, it is possible to satisfy both the durability and aestheticity of the timepiece part at a high level and decrease the angle dependency of the appearance of the timepiece part.

In the timepiece part according to an aspect of the invention, it is preferable that the third region has a thickness of 10 nm or more.

With this configuration, it is possible to make the gap between the first region and the second region more preferable and decrease the angle dependency of the appearance of the timepiece part. In addition, it is possible to more effectively enhance the durability and more effectively prevent unintended thickness increase, or the like of the timepiece part.

In the timepiece part according to the aspect of the invention, it is preferable that the tone film has a layer constituted of a material including at least one compound selected from the group consisting of Ta₂O₅, SiO₂, TiO₂, Al₂O₃, ZrO₂, Nb₂O₅, and HfO₂.

With this configuration, it is possible to make the aestheticity of the timepiece part superior and broaden the range of tone that can be expressed by the entire timepiece part. In addition, the above-described compounds are materials having particularly high chemical stability among a variety of metallic oxides and are capable of making the stability and durability of the appearance of the entire timepiece part superior.

In the timepiece part according to the aspect of the invention, it is preferable that a thickness of the tone film is 100 nm or more and 2,000 nm or less.

With this configuration, it is possible to make the aestheticity of the timepiece part superior, broaden the color reproduction region, more effectively prevent the unintended peeling or the like of the tone film, make the durability and reliability of the timepiece part superior, and make the productivity of the timepiece part superior.

In the timepiece part according to the aspect of the invention, it is preferable that the second region is constituted of a material including Ti, Cr, or Al.

With this configuration, it is possible to preferably obtain metallic luster having a bluish luxurious feeling throughout the entire timepiece part.

It is preferable that the timepiece part according to the aspect of the invention is windshield glass, a dial, a case, or a band.

These parts (timepiece part) have a significant influence on the appearance of timepieces as a whole, and thus it is possible to make the aestheticity of the timepieces superior as a whole by applying the invention to these parts.

According to another aspect of the invention, there is provided a timepiece including the timepiece part according to an aspect of the invention.

In such a case, it is possible to provide a timepiece having an excellent appearance even without using noble metal as a main material.

### BRIEF DESCRIPTION OF THE DRAWINGS

The invention will be described with reference to the accompanying drawings, wherein like numbers reference like elements.

FIG. 1 is a cross-sectional view schematically showing a first embodiment of a timepiece part according to the invention.

FIG. 2 is a cross-sectional view schematically showing a second embodiment of the timepiece part according to the invention.

FIG. 3 is a cross-sectional view schematically showing a third embodiment of the timepiece part according to the invention.

FIG. 4 is a partial cross-sectional view schematically showing a preferred embodiment of a timepiece (wristwatch) according to the invention.

### DESCRIPTION OF EXEMPLARY EMBODIMENTS

Hereinafter, preferred embodiments will be described in detail with reference to accompanying drawings.

### Timepiece Part

First, a timepiece part according to the invention will be described.

### First Embodiment

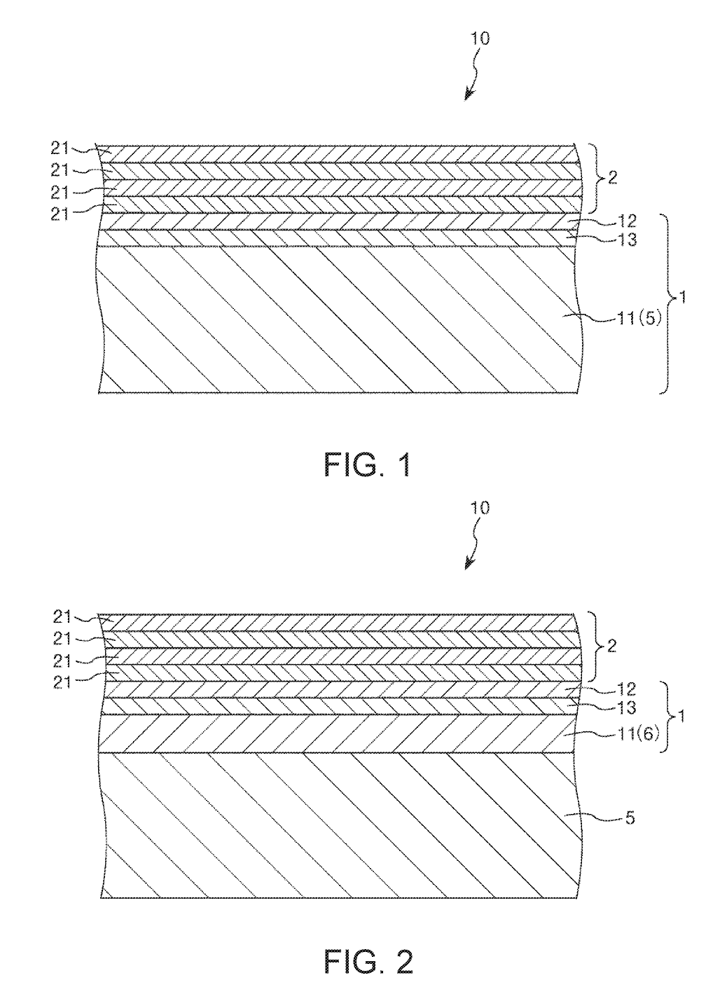

FIG. 1 is a cross-sectional view schematically showing a first embodiment of the timepiece part according to the invention.

A timepiece part 10 includes a metallic luster portion 1 which has a first region 11 constituted of a first material including a nitride or carbide of Ti, a nitride or carbide of Cr, or a metallic material, a film-like second region 12 constituted of a second material including a nitride or carbide of Ti, a nitride or carbide of Cr, or a metallic material, and a film-like third region 13 which is provided between the first region 11 and the second region 12 and is constituted of a light transmissive material and which exhibits metallic luster and includes atone film 2 which is provided on the second region 12 side of the metallic luster portion 1, is constituted of a multilayer film of a metallic oxide, and has a function of adjusting tone.

In the invention, “nitride” refers to a metallic compound including nitrogen (N), and carbonitrides and the like are included in the scope thereof. In addition, in the invention, “carbide” refers to a metallic compound including carbon (C), and carbonitrides and the like are included in the scope thereof.

The metallic luster portion 1 is a portion that exhibits a metallic luster feeling as a whole.

The tone film 2 is a member which uses the metallic luster feeling of the metallic luster portion 1 and has a function of adjusting the tone of the entire timepiece part 10.

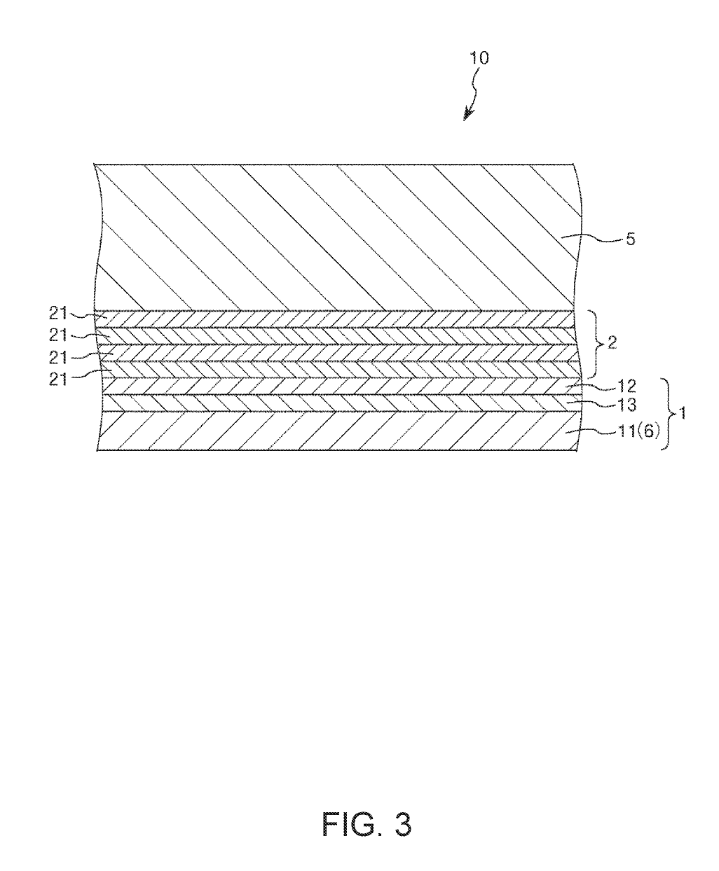

In addition, an observer's eye is in an upper side (a side of a surface on which the tone film 2 of the timepiece part 10 is provided (a side that is closer to the tone film 2 than the metallic luster portion 1 of the timepiece part 10)) of FIG. 1 (this is also true for FIGS. 2 and 3).

With the above-described constitution, it is possible to provide the timepiece part 10 having an excellent appearance (an appearance exhibiting metallic luster), particularly a luxurious feeling, even without using noble metal as a main material. In addition, even in a case in which noble metal is used, it is possible to suppress the amount of the noble metal used. More specifically, it is possible to obtain, for example, appearances having a feeling as luxurious as being exhibited by noble metal materials even without substantially including noble metal. Generally, noble metal has a characteristic of being easily blemished; however, when the above-described constitution is provided, it is possible to make the abrasion resistance and the like of the entire timepiece part 10 excellent. Particularly, in the timepiece part 10, it is possible to satisfy both an excellent appearance and excellent abrasion resistance. In addition, it is possible to express a variety of tones such as metal feelings having a bluish luster feeling and metal feelings having a reddish luster feeling which cannot be easily expressed by metallic materials alone, and it is possible to obtain appearances of having a tone which cannot be obtained in a case in which, simply, only a metallic material (particularly, a noble metal material) is used. That is, it is possible to broaden the color range (color reproduction region) that can be expressed. In addition, even for the metallic luster portion 1 constituted of a metallic material (for example, a metallic material or the like which has a relatively low chemical stability and easily proceeds with reactions such as oxidation), when the metallic luster portion is coated with the tone film 2 constituted of an oxide having an excellent chemical stability, the stability and durability of the entire timepiece part 10 improve.

In addition, in the metallic luster portion 1, when the third region 13 constituted of a light transmissive material is provided between the first region 11 and the second region 12, it is possible to provide a predetermined gap between the first region 11 and the second region 12 which exhibit metallic luster, and, with the use of optical interference with these regions, the angle dependency of the appearance of the timepiece part 10 is decreased, and aestheticity that is stably excellent at broad view angles can be obtained. In addition, when the first region 11 and the second region 12 are provided as a plurality of regions constituted of a material exhibiting metallic luster, it is possible to broaden the color range (color reproduction region) that can be expressed by the entire timepiece part 10 in combination with the effect of having the tone film 2.

Particularly, in the timepiece part 10 of the present embodiment, the first region 11 in the metallic luster portion 1 is a base material 5 constituted of the first material.

Therefore, it is possible to make the structure of the timepiece part 10 simpler and improve the productivity of the timepiece part 10.

### Base Material (First Region)

In the embodiment, the base material 5 (the first region 11) is constituted of the first material including a nitride or carbide of Ti, a nitride or carbide of Cr, or a metallic material. The first material exhibits metallic luster.

The metallic material constituting the first region 11 is preferably metal that is not as noble as noble metal, and examples thereof include Al, Ti, V, Cr, Fe, Co, Ni, Cu, Zn, Zr, Nb, Mo, In, Sn, Hf, Ta, W, Bi, Mg, alloys including at least one of the above-described metals, and the like. It should be noted that the first region may include a small amount of noble metal.

When the first region 11 is constituted of a material including Ti, Cr, or Al, it is possible to preferably obtain metallic luster having a bluish luxurious feeling throughout the entire timepiece part 10.

In addition, when the first region 11 is constituted of a nitride of Ti, it is possible to make the luster feeling of the entire timepiece part 10 superior.

In addition, when the first region 11 is constituted of a carbide of Ti, it is possible to preferably obtain black-tinged appearances having a luxurious feeling throughout the entire timepiece part 10. Particularly, it is possible to obtain appearances of blackish red, blackish blue, or the like which is particularly difficult to express in related art throughout the entire timepiece part 10.

In a case in which the first region 11 is constituted of a material including a carbonitride of Ti, it is possible to preferably express tones similar to, for example, pink gold.

In the first region 11, the content ratio of noble metal elements (Au, Ag, Pt, Pd, Rh, Ir, Ru, and Os) is preferably sufficiently small, and the content ratio (in a case in which the first region includes a plurality of kinds of noble metal elements, the sum of the content ratios thereof) of noble metal elements in the first region 11 is preferably 1.0% by mass or less, more preferably 0.5% by mass or less, and still more preferably 0.1% by mass or less.

In such a case, the effect of the invention enabling the obtainment of excellent appearances even without using noble metal as a main material is more significantly exhibited.

The first region 11 may include components other than nitrides and carbides of Ti, nitrides and carbides of Cr, and metallic materials as long as the first region has a metallic luster feeling. Here, the content ratio of the components other than the above-described materials (nitrides and carbides of Ti, nitrides and carbides of Cr, and metallic materials) in the first region 11 is preferably 5% by mass or less and more preferably 1% by mass or less.

A thickness of the first region 11 is preferably 10 nm or more, more preferably 20 nm or more, and still more preferably 30 nm or more.

In such a case, it is possible to make the luster feeling and aestheticity of the entire timepiece part 10 superior.

The base material 5 may have a composition which is uniform throughout portions or varies depending on portions. For example, the base material 5 may be a base material having a base portion and at least one film that coats the base portion and has a different composition from the base portion, a base material constituted of a gradient material having a composition that changes in a gradient manner (for example, a gradient material having a composition that changes in a gradient manner in the thickness direction or the like), or the like.

The shape and size of the base material 5 are not particularly limited and are generally determined on the basis of the shape and size of the timepiece part 10. In addition, a bumpy pattern of alphabetic character, numeric characters, symbols, shapes, and the like may be provided in the base material 5.

The base material 5 may have a surface on which, for example, surface machining such as mirror-like finishing, stamping, or pearskin finishing has been carried out.

In such a case, it becomes possible to impart variation to the luster status of the surface of the timepiece part 10, and it is possible to further improve the aestheticity of the timepiece part 10. Mirror-like finishing can be carried out using, for example, a well-known polishing method, and it is possible to employ, for example, buffing, barrel polishing, other mechanical polishing, or the like.

In the timepiece part 10 that is manufactured using the base material 5 on which the above-described surface machining has been carried out, compared with timepiece parts that are obtained by directly carrying out surface machining on a variety of films described below in detail, sparkling and the like are further suppressed, and particularly, the aestheticity becomes superior. In addition, the variety of films described below in detail are generally relatively thin, and, in a case in which surface machining is directly carried out on the films, imperfection such as chipping or peeling is likely to occur in the films during the surface machining, and there are cases in which the manufacturing yield of the timepiece part 10 significantly decreases. In contrast, when surface machining is carried out on the base material 5, it is possible to effectively prevent the occurrence of the above-described problem, and the aestheticity of surface machining is not impaired due to the relatively thin film thickness. In addition, surface machining on the base material 5 can be easily carried out under milder conditions compared with surface machining on the variety of films described below in detail.

### Second Region

The second region 12 is a film-like region constituted of the second material including a nitride or carbide of Ti, a nitride or carbide of Cr, or a metallic material. The second material exhibits metallic luster.

Examples of the metallic material constituting the second region 12 include the metallic materials exemplified as the constituent material of the first region 11.

When the second region 12 is constituted of a material including Ti, Cr, or Al, it is possible to preferably obtain metallic luster having a bluish luxurious feeling throughout the entire timepiece part 10.

Particularly, when the second region 12 as well as the first region 11 is constituted of a material including Ti, Cr, or Al, the above-described effect is more significantly exhibited, and it is possible to make the aestheticity of the entire timepiece part 10 superior and obtain bluish metallic luster having a luxurious feeling.

In addition, when the second region 12 is constituted of a nitride of Ti or Cr, it is possible to preferably obtain gold-color appearances (appearances that are similar to that of Au as a single body) having a luxurious feeling throughout the entire timepiece part 10. Particularly, when the second region 12 as well as the first region 11 is constituted of a nitride of Ti or Cr, it is possible to make the luxurious feeling of the entire timepiece part 10 superior.

In addition, when the second region 12 is constituted of a carbide of Ti, it is possible to preferably obtain black-tinged appearances having a luxurious feeling throughout the entire timepiece part 10. Particularly, it is possible to obtain appearances of blackish red, blackish blue, or the like which is particularly difficult to express in related art throughout the entire timepiece part 10.

In a case in which the second region 12 is constituted of a material including a carbonitride of Ti, it is possible to preferably express tones similar to, for example, pink gold.

In the second region 12, the content ratio of noble metal elements (Au, Ag, Pt, Pd, Rh, Ir, Ru, and Os) is preferably sufficiently small, and the content ratio (in a case in which the second region includes a plurality of kinds of noble metal elements, the sum of the content ratios thereof) of noble metal elements in the second region 12 is preferably 1.0% by mass or less, more preferably 0.5% by mass or less, and still more preferably 0.1% by mass or less.

In such a case, the effect of the invention enabling the obtainment of excellent appearances even without using noble metal as a main material is more significantly exhibited.

The second region 12 may include components other than nitrides and carbides of Ti, nitrides and carbides of Cr, and metallic materials as long as the second region has a metallic luster feeling. Here, the content ratio of the components other than the above-described materials (nitrides and carbides of Ti, nitrides and carbides of Cr, and metallic materials) in the second region 12 is preferably 5% by mass or less and more preferably 1% by mass or less.

A thickness of the second region 12 is preferably 200 nm or less, more preferably 180 nm or less, and still more preferably 1nm or more and 160 nm or less.

In such a case, it is possible to make the luster feeling and aestheticity of the entire timepiece part 10 superior. In addition, the angle dependency of the appearance of the timepiece part 10 is decreased, and aestheticity that is stably excellent at broad view angles can be obtained.

The second region 12 may have a composition which is uniform throughout portions or varies depending on portions. For example, the second region 12 may be a laminate obtained by laminating a plurality of layers, a region constituted of a gradient material having a composition that changes in a gradient manner (for example, a gradient material having a composition that changes in a gradient manner in the thickness direction or the like), or the like.

The forming method of the second region 12 is not particularly limited, examples thereof include coating such as spin coating, dip coating, brush coating, spray coating, electrostatic coating, and electrodeposition coating, wet-type plating methods such as electrolytic plating, immersion plating, and non-electrolytic plating, chemical vapor deposition (CVD) methods such as thermal CVD, plasma CVD, and laser CVD, dry-type plating methods (gas-phase film-forming methods) such as vacuum deposition, sputtering, ion plating, and laser abrasion, thermal spraying, and the like, and dry-type plating methods (gas-phase film-forming methods) are preferred.

When a dry-type plating method (gas-phase film-forming method) is applied as the forming method of the second region 12, it is possible to reliably form the second region 12 which has a uniform film thickness, is homogeneous, and has a particularly excellent adhesiveness to the third region 13 and the like. As a result, it is possible to make the aesthetic appearance and durability of the timepiece part 10 particularly excellent.

In addition, when a dry-type plating method (gas-phase film-forming method) is applied as the forming method of the second region 12, it is possible to sufficiently decrease unintended variation in the film thickness even when the second region 12 that needs to be formed is relatively thin. Therefore, the use of the dry-type plating method is also advantageous from the viewpoint of improving the reliability of the timepiece part 10.

Among the above-described dry-type plating methods (gas-phase film-forming methods), ion plating is particularly preferred.

When ion plating is applied as the forming method of the second region 12, the above-described effect becomes more significant. That is, when ion plating is applied as the forming method of the second region 12, it is possible to reliably form the second region 12 which has a uniform film thickness, is homogeneous, and has a particularly excellent adhesiveness to the third region 13 and the like. As a result, it is possible to make the aesthetic appearance and durability of the timepiece part 10 that is finally obtained superior.

In addition, when ion plating is applied as the forming method of the second region 12, it is possible to particularly decrease unintended variation in the film thickness even when the second region 12 that needs to be formed is relatively thin.

### Third Region

The third region 13 is a film-like region which is provided between the first region 11 and the second region 12 and is constituted of a light transmissive material.

The third region 13 needs to be constituted of a light transmissive material, and the transmittance of visible light in the third region 13 (for example, the transmittance of light at a wavelength of 550 nm) is preferably 80% or more, more preferably 85% or more, and still more preferably 90% or more.

In such a case, in the appearance of the timepiece part 10, it is possible to more effectively use the reflection of light on the surfaces of the first region 11 and the second region 12, the angle dependency of the appearance of the timepiece part 10 is decreased, and aestheticity that is stably excellent at broad view angles can be obtained.

Examples of a constituent material of the third region 13 include glass materials such as sapphire glass, soda glass, crystalline glass, silica glass, lead glass, potassium glass, borosilicate glass, and alkali-free glass, plastic materials such as a variety of thermoplastic resins and a variety of thermosetting resins, metallic oxides, DLC, and the like, and metallic oxides are preferred.

In such a case, it is possible to satisfy both the durability and aestheticity of the timepiece part 10 at a higher level and decrease the angle dependency of the appearance of the timepiece part 10.

As the metallic oxide constituting the third region 13, a variety of metallic oxides can be used, and metallic oxides including at least one compound selected from the group consisting of Ta₂O₅, SiO₂, TiO₂, Al₂O₃, ZrO₂, Nb₂O₅, and HfO₂ are preferred.

In such a case, it is possible to make the transparency of the third region 13 higher (make the degree of coloration of the third region 13 smaller), make the aestheticity of the timepiece part 10 superior, and make the angle dependency of the appearance of the timepiece part 10 smaller. In addition, the above-described compounds are materials having particularly high chemical stability among a variety of metallic oxides and are capable of making the stability and durability of the appearance of the entire timepiece part 10 superior.

Among the compounds, Al₂O₃ and HfO₂ are materials having a particularly high hardness and have not only chemical durability but also excellent durability with respect to mechanical forces.

In a case in which the third region 13 is constituted of a material including the metallic oxide, the third region 13 may include components other than the metallic oxide. Here, the content ratio of the components other than the metallic oxide in the third region 13 is preferably 5% by mass or less and more preferably 1% by mass or less.

The third region 13 may have a composition which is uniform throughout portions or varies depending on portions. For example, the third region 13 may be a laminate obtained by laminating a plurality of layers, a region constituted of a gradient material having a composition that changes in a gradient manner (for example, a gradient material having a composition that changes in a gradient manner in the thickness direction or the like), or the like.

A thickness of the third region 13 is preferably 10 nm or more, more preferably 15 nm or more, and still more preferably 20 nm or more and 5,000 nm or less.

In such a case, it is possible to make the gap between the first region 11 and the second region 12 more preferable and make the angle dependency of the appearance of the timepiece part 10 smaller. In addition, it is possible to more effectively enhance the durability and more effectively prevent unintended thickness increase, or the like of the timepiece part 10.

The third region 13 may have a thickness which is uniform throughout portions or varies depending on regions. In such a case, it is possible to make the angle dependency of the appearance of the timepiece part 10 vary depending on portions, and it is possible to provide diversity to the appearance of the timepiece part 10 in a case in which the angle (gradient) with respect to the incident direction of external light is changed.

The forming method of the third region 13 is not particularly limited, examples thereof include coating such as spin coating, dip coating, brush coating, spray coating, electrostatic coating, and electrodeposition coating, wet-type plating methods such as electrolytic plating, immersion plating, and non-electrolytic plating, chemical vapor deposition (CVD) methods such as thermal CVD, plasma CVD, and laser CVD, dry-type plating methods (gas-phase film-forming methods) such as vacuum deposition, sputtering, ion plating, and laser abrasion, thermal spraying, and the like, and dry-type plating methods (gas-phase film-forming methods) are preferred.

When a dry-type plating method (gas-phase film-forming method) is applied as the forming method of the third region 13, it is possible to reliably form the third region 13 which has a uniform film thickness, is homogeneous, and has a particularly excellent adhesiveness to the first region 11 and the like. As a result, it is possible to make the aesthetic appearance and durability of the timepiece part 10 particularly excellent.

In addition, when a dry-type plating method (gas-phase film-forming method) is applied as the forming method of the third region 13, it is possible to sufficiently decrease variation in the film thickness even when the third region 13 that needs to be formed is relatively thin. Therefore, the use of the dry-type plating method is also advantageous from the viewpoint of improving the reliability of the timepiece part 10.

In addition, when a dry-type plating method (gas-phase film-forming method) is applied as the forming method of the third region 13, it is possible to more reliably control the content ratio of oxygen or the like in individual portions in the third region 13.

Among the above-described dry-type plating methods (gas-phase film-forming methods), ion plating is particularly preferred.

When ion plating is applied as the forming method of the third region 13, the above-described effect becomes more significant. That is, when ion plating is applied as the forming method of the third region 13, it is possible to reliably form the third region 13 which has a uniform film thickness, is homogeneous, and has a particularly excellent adhesiveness to the first region 11 and the like. As a result, it is possible to make the aesthetic appearance and durability of the timepiece part 10 that is finally obtained superior.

In addition, when ion plating is applied as the forming method of the third region 13, it is possible to particularly decrease variation in the film thickness even when the third region 13 that needs to be formed is relatively thin.

In addition, when ion plating is applied as the forming method of the third region 13, it is possible to more reliably control the content ratio of oxygen or the like in individual portions in the third region 13.

In addition, in a case in which the third region 13 is formed using a dry-type plating method, it is possible to successively form the second region 12 and the third region 13 in the same device without removing the base material 5 from the device by, for example, changing targets.

In such a case, the adhesiveness between the second region 12 and the third region 13 becomes particularly excellent, and the productivity of the timepiece part 10 also improves.

### Tone Film

The tone film 2 is constituted of a multilayer film of a metallic oxide. In other words, the tone film 2 is a laminate including a plurality of metallic oxide layers 21.

The tone film 2 (the metallic oxide layer 21) needs to be constituted of an oxide of a metallic material, and the tone film 2 preferably has a layer (the metallic oxide layer 21) constituted of a material including at least one compound selected from the group consisting of Ta₂O₅, SiO₂, TiO₂, Al₂O₃, ZrO₂, Nb₂O₅, and HfO₂, and more preferably has layers constituted of mutually different materials that are selected from the above-described group as the plurality of metallic oxide layers 21.

In such a case, it is possible to make the aestheticity of the timepiece part 10 superior and broaden the range of tone that can be expressed by the entire timepiece part 10. In addition, the above-described compounds are materials having particularly high chemical stability among a variety of metallic oxides and are capable of making the appearance stability and durability of the entire timepiece part 10 superior.

Among the compounds, Al₂O₃ and HfO₂ are materials having a particularly high hardness and have not only chemical durability but also excellent durability with respect to mechanical forces.

The tone film 2 (the metallic oxide layer 21) needs to be constituted mainly of a metallic oxide and may include components other than the metallic oxide. Here, the content ratio of the components other than the metallic oxide in the tone film 2 (the metallic oxide layer 21) is preferably 5% by mass or less and more preferably 1% by mass or less.

In addition, the tone film 2 may have layers other than the metallic oxide layers 21, which are not illustrated, as, for example, interlayers provided between the metallic oxide layers 21.

A thickness of the tone film 2 is preferably 100 nm or more and 2,000 nm or less, more preferably 150 nm or more and 1,000 nm or less, and still more preferably 200 nm or more and 800 nm or less.

In such a case, it is possible to make the aestheticity of the timepiece part 10 superior, broaden the color reproduction region, more effectively prevent the unintended peeling or the like of the tone film 2, make the durability and reliability of the timepiece part 10 superior, and make the productivity of the timepiece part 10 superior.

The tone film 2 may have a thickness which is uniform throughout portions or varies depending on regions.

In such a case, it is possible to make the angle dependency of the appearance of the timepiece part 10 vary depending on portions, and it is possible to provide diversity to the appearance of the timepiece part 10 in a case in which the angle (gradient) with respect to the incident direction of external light is changed.

Thicknesses of the respective layers (the respective metallic oxide layers 21) constituting the tone film 2 are respectively preferably 10 nm or more and 300 nm or less, more preferably 15 nm or more and 200 nm or less, and still more preferably 25 nm or more and 150 nm or less.

In such a case, it is possible to make the aestheticity of the timepiece part 10 superior, broaden the color reproduction region, more effectively prevent the unintended peeling or the like of the tone film 2, and make the durability and reliability of the timepiece part 10 superior.

The number of the metallic oxide layers 21 constituting the tone film 2 is preferably two or more and more preferably three or more.

In such a case, it is possible to make the aestheticity of the timepiece part 10 superior, broaden the color reproduction region, more effectively prevent the unintended peeling or the like of the tone film 2, and make the durability and reliability of the timepiece part 10 superior.

The forming method of the tone film 2 is not particularly limited, examples thereof include coating such as spin coating, dip coating, brush coating, spray coating, electrostatic coating, and electrodeposition coating, wet-type plating methods such as electrolytic plating, immersion plating, and non-electrolytic plating, chemical vapor deposition (CVD) methods such as thermal CVD, plasma CVD, and laser CVD, dry-type plating methods (gas-phase film-forming methods) such as vacuum deposition, sputtering, ion plating, and laser abrasion, thermal spraying, and the like, and dry-type plating methods (gas-phase film-forming methods) are preferred.

When a dry-type plating method (gas-phase film-forming method) is applied as the forming method of the tone film 2, it is possible to reliably form the tone film 2 which has a uniform film thickness, is homogeneous, and has a particularly excellent adhesiveness to the second region 12 and the like. As a result, it is possible to make the aesthetic appearance and durability of the timepiece part 10 particularly excellent.

In addition, when a dry-type plating method (gas-phase film-forming method) is applied as the forming method of the tone film 2, it is possible to sufficiently decrease variation in the film thickness even when the respective metallic oxide layers 21 constituting the tone film 2 that needs to be formed are relatively thin. Therefore, the use of the dry-type plating method is also advantageous from the viewpoint of improving the reliability of the timepiece part 10.

In addition, when a dry-type plating method (gas-phase film-forming method) is applied as the forming method of the tone film 2, it is possible to more reliably control the content ratio of oxygen or the like in the respective portions (the respective metallic oxide layers 21) in the tone film 2.

Among the above-described dry-type plating methods (gas-phase film-forming methods), ion plating is particularly preferred.

When ion plating is applied as the forming method of the tone film 2, the above-described effect becomes more significant. That is, when ion plating is applied as the forming method of the tone film 2, it is possible to reliably form the tone film 2 which has a uniform film thickness, is homogeneous, and has a particularly excellent adhesiveness to the second region 12 and the like. As a result, it is possible to make the aesthetic appearance and durability of the timepiece part 10 that is finally obtained superior.

In addition, when ion plating is applied as the forming method of the tone film 2, it is possible to particularly decrease variation in the film thickness even when the respective metallic oxide layers 21 constituting the tone film 2 that needs to be formed are relatively thin.

In addition, when ion plating is applied as the forming method of the tone film 2, it is possible to more reliably control the content ratio of oxygen or the like in the respective portions (the respective metallic oxide layers 21) in the tone film 2.

In addition, in a case in which the tone film 2 is formed using a dry-type plating method, it is possible to successively form the respective metallic oxide layers 21 constituting the tone film 2 in the same device without removing the base material 5 from the device by, for example, setting a plurality of targets.

In such a case, the adhesiveness between the respective layers constituting the tone film 2 becomes particularly excellent, and the productivity of the timepiece part 10 also improves.

### Second Embodiment

Next, a timepiece part of a second embodiment will be described.

FIG. 2 is a cross-sectional view schematically showing the second embodiment of the timepiece part according to the invention. In the following description, differences from the above-described embodiment will be mainly described, and the same contents will not be described.

A timepiece part 10 of the present embodiment has a structure in which a base material 5 constituted of a material not substantially including any of a nitride and a carbide of Ti, a nitride and a carbide of Cr, and a metallic material, a metallic luster portion 1 exhibiting metallic luster, and a tone film 2 which is constituted of a multilayer film of a metallic oxide and has a function of adjusting tone are laminated in this order, and the metallic luster portion 1 has a structure in which a first region 11 as a coating 6 constituted of a first material, a film-like second region 12 constituted of a second material, and a film-like third region 13 which is provided between the first region 11 and the second region 12 and is constituted of a light transmissive material are laminated in this order from a base material 5 side. In other words, in the timepiece part 10 of the embodiment, the first region 11 constituting the metallic luster portion 1 is the coating 6 provided on the base material 5 constituted of a material not substantially including any of a nitride and a carbide of Ti, a nitride and a carbide of Cr, and a metallic material.

As described above, when the coating 6 is provided as a portion that is different from the base material 5 and as the first region 11, the range of choice of the constituent material and the like of the base material 5 broadens. For example, it is also possible to preferably use glass, ceramic, plastic materials, and the like as the constituent material of the base material 5, and it is possible to broaden the range of choice of the molding method of the timepiece part 10, the range of choice of the disposition portion of the timepiece part 10 in timepieces, and the like. In addition, it is possible to decrease the amount of the metallic materials used for the entire timepiece part 10. Therefore, it is possible to contribute to, for example, the weight reduction of the timepiece part 10. In addition, it is possible to make the radio wave-transmitting property of the timepiece part 10 excellent and preferably apply the timepiece part 10 to, for example, radio wave timepieces and the like. In addition, when a base material constituted of a light transmissive material is used as the base material 5, and the thickness of the coating 6 is set to be relatively thin, it is possible to exhibit the excellent luster feeling and aestheticity of the timepiece part 10 as a whole and ensure a sufficient light-transmitting property. As a result, it is possible to preferably apply the timepiece part 10 to, for example, components requiring a light-transmitting property such as windshield glass and skeleton-type rear cases.

### Base Material

In the embodiment, examples of a constituent material of the base material 5 include glass materials such as sapphire glass, soda glass, crystalline glass, silica glass, lead glass, potassium glass, borosilicate glass, and alkali-free glass, ceramic materials such as alumina and titania, plastic materials such as a variety of thermoplastic resins and a variety of thermosetting resins, and the like.

In the embodiment, the base material 5 needs not to substantially include any of a nitride and a carbide of Ti, a nitride and a carbide of Cr, and a metallic material; however, as long as the amount is small, the base material may include nitrides or carbides of Ti, nitrides or carbides of Cr, or metallic materials as, for example, fillers, inevitable components, or the like. For example, the base material 5 may include nitrides and carbides of Ti, nitrides and carbides of Cr, and metallic materials as long as the sum of the content ratios thereof is 5% by mass or less. In such a case, the above-described effect can be sufficiently obtained.

### Coating (First Region)

In the embodiment, the coating 6 functions as the first region 11.

Examples of a constituent material of the coating 6 include the same material exemplified for the base material 5 (the first region 11) in the above-described embodiment. That is, in the embodiment, the coating 6 is constituted of the first material.

A thickness of the coating 6 is preferably 10 nm or more and 5,000 nm or less, more preferably 20 nm or more and 3,000 or less, and still more preferably 30 nm or more and 500 nm or less.

In such a case, it is possible to make the luster feeling and aestheticity of the entire timepiece part 10 superior, more effectively prevent the unintended peeling or the like of the coating 6, make the durability of the timepiece part 10 superior, and make the productivity of the timepiece part 10 superior.

The coating 6 may have a composition which is uniform throughout portions or varies depending on portions. For example, the coating 6 may be a laminate obtained by laminating a plurality of layers, a coating constituted of a gradient material having a composition that changes in a gradient manner (for example, a gradient material having a composition that changes in a gradient manner in the thickness direction or the like), or the like.

The forming method of the coating 6 is not particularly limited, examples thereof include coating such as spin coating, dip coating, brush coating, spray coating, electrostatic coating, and electrodeposition coating, wet-type plating methods such as electrolytic plating, immersion plating, and non-electrolytic plating, chemical vapor deposition (CVD) methods such as thermal CVD, plasma CVD, and laser CVD, dry-type plating methods (gas-phase film-forming methods) such as vacuum deposition, sputtering, ion plating, and laser abrasion, thermal spraying, and the like, and dry-type plating methods (gas-phase film-forming methods) are preferred.

When a dry-type plating method (gas-phase film-forming method) is applied as the forming method of the coating 6, it is possible to reliably form the coating 6 which has a uniform film thickness, is homogeneous, and has a particularly excellent adhesiveness to the base material 5 and the like. As a result, it is possible to make the aesthetic appearance and durability of the timepiece part 10 particularly excellent.

In addition, when a dry-type plating method (gas-phase film-forming method) is applied as the forming method of the coating 6, it is possible to sufficiently decrease variation in the film thickness even when the coating 6 that needs to be formed is relatively thin. Therefore, the use of the dry-type plating method is also advantageous from the viewpoint of improving the reliability of the timepiece part 10.

Among the above-described dry-type plating methods (gas-phase film-forming methods), ion plating is particularly preferred.

When ion plating is applied as the forming method of the coating 6, the above-described effect becomes more significant. That is, when ion plating is applied as the forming method of the coating 6, it is possible to reliably form the coating 6 which has a uniform film thickness, is homogeneous, and has a particularly excellent adhesiveness to the base material 5 and the like. As a result, it is possible to make the aesthetic appearance and durability of the timepiece part 10 that is finally obtained superior.

In addition, when ion plating is applied as the forming method of the coating 6, it is possible to particularly decrease variation in the film thickness even when the coating 6 that needs to be formed is relatively thin.

### Third Embodiment

Next, a timepiece part of a third embodiment will be described.

FIG. 3 is a cross-sectional view schematically showing the third embodiment of the timepiece part according to the invention. In the following description, differences from the above-described embodiment will be mainly described, and the same contents will not be described.

In a timepiece part 10 of the present embodiment, a base material 5 has a light-transmitting property, the base material 5, a tone film 2, and a metallic luster portion 13 are laminated in this order, and, in the metallic luster portion 1, a second region 12, a third region 13, and a first region 11 (a coating 6) are laminated in this order from a tone film 2 side.

As described above, the disposition of the respective members constituting the timepiece part 10 may be different from the above-described disposition.

In addition, when the base material 5, the tone film 2, and the metallic luster portion 1 are laminated in this order as in the embodiment, it is possible to make the tone film 2 and the metallic luster portion 1 observable to observers through the base material 5 which has a predetermined thickness and a light-transmitting property, and thus it is possible to impart a depth feeling to the appearance of the timepiece part 10.

The base material 5 needs to have a light-transmitting property, and the transmittance of visible light in the base material 5 (for example, the transmittance of light at a wavelength of 550 nm) is preferably 80% or more, more preferably 85% or more, and still more preferably 90% or more.

In such a case, the effect of the above-described disposition is more significantly exhibited, and it is possible to make the aestheticity of the timepiece part 10 superior.

The timepiece part 10 is not particularly limited as long as the timepiece part is a component constituting a timepiece, but is preferably a component that can be observed from the outside during the use of the timepiece. Specific examples thereof include windshield glass, cases, bezels, rear cases, bands (including band pieces, band clasps, clasps, buckles, band/bangle-removing mechanisms, and the like), dials, needles for timepieces, rotors, winding knobs (for example, screw-locking-type winding knobs and the like), buttons, dial rings, dial covers, and the like, and, among these, windshield glass, dials, cases, or bands are preferred.

These parts (timepiece part) have a significant influence on the appearance of the entire timepiece, and thus it is possible to make the aestheticity of the entire timepiece superior by applying the invention to these parts.

### Timepiece

Next, a timepiece according to the invention will be described.

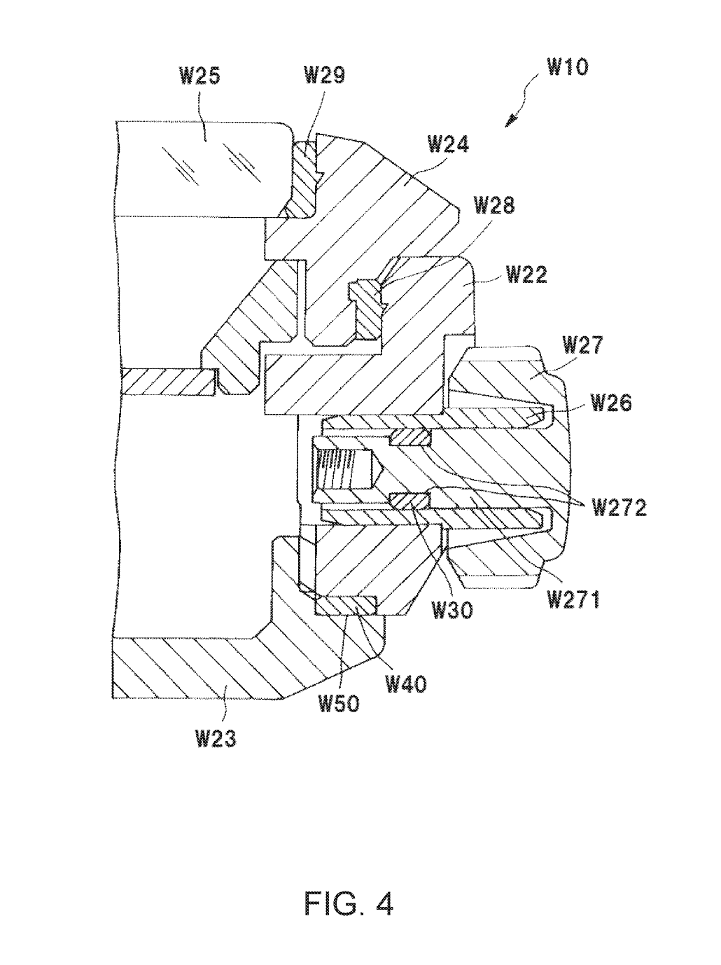

FIG. 4 is a partial cross-sectional view schematically showing a preferred embodiment of the timepiece (wristwatch) according to the invention.

A wristwatch (timepiece) W10 of the present embodiment includes a trunk (case) W22, a rear case W23, a bezel (edge) W24, and a glass plate (windshield glass) W25. In addition, in the case W22, a movement (for example, a movement equipped with a dial and needles), not shown, is stored.

A winding stem pipe W26 is inserted into and fixed to the trunk W22, and a shaft portion W271 of a winding knob W27 is inserted into the winding stem pipe W26 so as to be capable of rotating.

The trunk W22 and the bezel W24 are fixed to each other using a plastic packing W28, and the bezel W24 and the glass plate W25 are fixed to each other using a plastic packing W29.

In addition, the rear case W23 is fitted (screwed) into the trunk W22, and a ring-shaped rubber packing (rear case packing) W40 is interposed in a joint portion (seal portion) W50 between the rear case and the trunk in a compressed state. Due to this constitution, the seal portion W50 is liquid-tightly sealed, and a waterproof function is obtained.

A groove W272 is formed in an outer circumference in the middle of the shaft portion W271 of the winding knob W27, and a ring-shaped rubber packing (winding knob packing) W30 is fitted into the groove W272. The rubber packing W30 is tightly attached to an inner circumferential surface of the winding step pipe W26 and is compressed between the inner circumferential surface and an inner surface of the groove W272. Due to this constitution, a gap between the winding knob W27 and the winding stem pipe W26 is liquid-tightly sealed, and a waterproof function is obtained. When the winding knob W27 is rotary-operated, the rubber packing W30 rotates together with the shaft portion W271 and slides in a circumferential direction while being tightly attached to the inner circumferential surface of the winding stem pipe W26.

In the wristwatch W10 as the timepiece according to the invention, at least one of the constituent components is a component constituted of the timepiece part according to the invention as described above. In other words, the timepiece according to the invention includes the timepiece part according to the invention.

Therefore, it is possible to provide the timepiece W10 having an excellent appearance (an appearance exhibiting metallic luster), particularly a luxurious feeling, even without using noble metal as a main material.

Hitherto, the preferred embodiments of the invention have been described, but the invention is not limited thereto.

For example, in the timepiece part and the timepiece according to the invention, it is possible to substitute the constitutions of the respective portions with arbitrary constitutions exhibiting the same function, and it is also possible to add arbitrary constitutions.

For example, at least one interlayer may also be provided between the metallic luster portion and the tone film.

In addition, the metallic luster portion may have, in addition to the first region, the second region, and the third region, regions other than the above-described regions. For example, an arbitrary layer (film) may be provided between the first region and the third region or between the third region and the second region.

In addition, in the above-described embodiments, the constitution in which the tone film is provided on one surface side of the metallic luster portion has been representatively described, but tone films may be provided on both side surfaces of the metallic luster portion respectively.

In addition, in at least one portion of the surface of the timepiece part, a coating layer (protective layer) or the like which imparts corrosion resistance, weather resistance, water resistance, oil resistance, abrasion resistance, wear resistance, discoloration resistance, and the like and improves antirust, antifouling, antifogging, anti-scratch and other effects may be formed. The above-described coating layer may be removed during the use or the like of the timepiece part.

### EXAMPLES

Next, specific examples of the invention will be described.

[1] Manufacturing of timepiece part

### Example 1

First, a base material having a dial shape (first region) was produced by punching an aluminum plate, and then necessary places were cut and polished. The obtained base material formed a substantially disc shape and had a diameter of approximately 27 mm and a thickness of approximately 0.5 mm.

Next, this base material was washed. For the washing of the base material, first, alkali electrolytic degreasing was carried out for 30 seconds, and then 10-second neutralization, 10-second water washing, and 10-second pure water washing were carried out respectively.

Next, a 131 nm-thick third region constituted of SiO₂ was formed on one surface of the base material by means of ion plating.

Subsequently, a 6 nm-thick second region constituted of Al was formed on a surface of the third region by means of ion plating. Therefore, a metallic luster portion made up of the first region, the second region, and the third region was formed.

Subsequently, a tone film constituted of a multilayer film of a metallic oxide was formed on a surface of the third region by means of ion plating, thereby obtaining a dial as a timepiece part.

The tone film was formed so as to have a TiO2 layer (thickness: 22 nm), a SiO2 layer (thickness: 113 nm), a TiO2 layer (thickness: 40 nm), a SiO2 layer (thickness: 50 nm), and a TiO2 layer (thickness: 27 nm) laminated in this order from a third region side.

### Example 2

First, a base material having a dial shape was produced using polycarbonate by means of compression molding, and then necessary places were cut and polished. The obtained base material formed a substantially disc shape and had a diameter of approximately 27 mm and a thickness of approximately 0.5 mm.

Next, this base material was washed. For the washing of the base material, first, alkali immersion degreasing was carried out for 30 seconds, and then 10-second neutralization, 10-second water washing, and 10-second pure water washing were carried out respectively.

Next, a 100 nm-thick coating (first region) constituted of TiN was formed on one surface of the base material by means of ion plating.

Subsequently, a 124 nm-thick third region constituted of SiO₂ was formed on a surface of the coating by means of ion plating.

Subsequently, a 80 nm-thick second region constituted of TiN was formed on a surface of the third region by means of ion plating. Therefore, a metallic luster portion made up of the first region, the second region, and the third region was formed.

Subsequently, a tone film constituted of a multilayer film of a metallic oxide was formed on a surface of the coating (metallic luster portion) by means of ion plating, thereby obtaining a dial as a timepiece part.

The tone film was formed so as to have a SiO₂ layer (thickness: 66 nm), a Ta₂O₅ layer (thickness: 68 nm), a SiO₂ layer (thickness: 135 nm), and a Ta₂O₅ layer (thickness: 84 nm) laminated in this order from a coating (metallic luster portion) side.

### Example 3

A timepiece part (dial) was manufactured in the same manner as in Example 2 except for the fact that the constitutions of the coating (metallic luster portion) and the tone film were made as shown in Table 1 by adjusting the film-forming conditions during the formation of the coating (metallic luster portion) and the film-forming conditions during the formation of the tone film.

### Example 4

First, an inorganic glass base material having a windshield glass shape was prepared.

Next, this base material was washed. For the washing of the base material, first, alkali immersion degreasing was carried out for 30 seconds, and then 10-second neutralization, 10-second water washing, and 10-second pure water washing were carried out respectively.

Next, a tone film constituted of a multilayer film of a metallic oxide was formed on one surface of the base material by means of ion plating.

The tone film was formed so as to have a TiO2 layer (thickness: 36 nm), a SiO2 layer (thickness: 50 nm), a TiO2 layer (thickness: 45 nm), a SiO2 layer (thickness: 78 nm), and a TiO2 layer (thickness: 70 nm) laminated in this order from a base material side.

Subsequently, a 19 nm-thick coating (second region) constituted of Ti was formed on a surface of the tone film by means of ion plating.

Subsequently, a 135 nm-thick third region constituted of SiO₂ was formed on a surface of the second region by means of ion plating.

Subsequently, a 32 nm-thick coating (first region) constituted of Ti was formed on a surface of the third region by means of ion plating, thereby obtaining windshield glass as a timepiece part.

### Example 5

First, a base material having a dial shape (first region) was produced by punching an aluminum plate, and then necessary places were cut and polished. The obtained base material formed a substantially disc shape and had a diameter of approximately 27 mm and a thickness of approximately 0.5 mm.

Next, this base material was washed. For the washing of the base material, first, alkali electrolytic degreasing was carried out for 30 seconds, and then 10-second neutralization, 10-second water washing, and 10-second pure water washing were carried out respectively.

Next, a 130 nm-thick third region constituted of SiO₂ was formed on one surface of the base material by means of ion plating.

Subsequently, a 6 nm-thick second region constituted of Al was formed on a surface of the third region by means of ion plating. Therefore, a metallic luster portion made up of the first region, the second region, and the third region was formed.

Subsequently, a tone film constituted of a multilayer film of a metallic oxide was formed on a surface of the third region by means of ion plating, thereby obtaining a dial as a timepiece part.

The tone film was formed so as to have a Nb₂O₅ layer (thickness: 22 nm), a SiO₂ layer (thickness: 114 nm), a Nb₂O₅ layer (thickness: 38 nm), a SiO₂ layer (thickness: 53 nm), and a Nb₂O₅ layer (thickness: 25 nm) laminated in this order from a third region side.

### Example 6

First, a base material having a dial shape (first region) was produced by punching an aluminum plate, and then necessary places were cut and polished. The obtained base material formed a substantially disc shape and had a diameter of approximately 27 mm and a thickness of approximately 0.5 mm.

Next, this base material was washed. For the washing of the base material, first, alkali electrolytic degreasing was carried out for 30 seconds, and then 10-second neutralization, 10-second water washing, and 10-second pure water washing were carried out respectively.

Next, a 138 nm-thick third region constituted of SiO₂ was formed on one surface of the base material by means of ion plating.

Subsequently, a 6 nm-thick second region constituted of Al was formed on a surface of the third region by means of ion plating. Therefore, a metallic luster portion made up of the first region, the second region, and the third region was formed.

Subsequently, a tone film constituted of a multilayer film of a metallic oxide was formed on a surface of the third region by means of ion plating, thereby obtaining a dial as a timepiece part.

The tone film was formed so as to have a ZrO₂ layer (thickness: 23 nm), a SiO₂ layer (thickness: 125 nm), a ZrO₂ layer (thickness: 37 nm), a SiO₂ layer (thickness: 56 nm), and a ZrO₂ layer (thickness: 30 nm) laminated in this order from a third region side.

### Example7

First, a base material having a dial shape was produced by punching a stainless steel plate material, and then necessary places were cut and polished. The obtained base material formed a substantially disc shape and had a diameter of approximately 27 mm and a thickness of approximately 0.5 mm.

Next, this base material was washed. For the washing of the base material, first, alkali electrolytic degreasing was carried out for 30 seconds, and then 10-second neutralization, 10-second water washing, and 10-second pure water washing were carried out respectively.

Next, a 150 nm-thick coating (first region) constituted of TiCN was formed on one surface of the base material by means of ion plating.

Subsequently, a 205 nm-thick third region constituted of SiO₂was formed on a surface of the coating by means of ion plating.

Subsequently, a 80 nm-thick second region constituted of TiCN was formed on a surface of the third region by means of ion plating.

Subsequently, a tone film constituted of a multilayer film of a metallic oxide was formed on a surface of the third region by means of ion plating, thereby obtaining a dial as a timepiece part.

The tone film was formed so as to have a ZrO₂ layer (thickness: 120 nm) and a SiO₂ layer (thickness: 77 nm) laminated in this order from a coating (metallic luster portion) side.

### Examples 8 to 10

Timepiece parts (dials) were manufactured in the same manner as in Example 7 except for the fact that the constitutions were made as shown in Table 1 by adjusting the film-forming conditions during the formation of the coatings (first region, third region, and second region) and the film-forming conditions during the formation of the tone film.

### Examples 11 and 12

Timepiece parts (dials) were manufactured in the same manner as in Example 2 except for the fact that the constitutions of the coating (metallic luster portion) and the tone film were made as shown in Table 1 by adjusting the film-forming conditions during the formation of the coatings (metallic luster portion) and the film-forming conditions during the formation of the tone film.

### Comparative Example 1

A timepiece part (dials) was manufactured in the same manner as in Example 1 except for the fact that the tone film was not formed.

### Comparative Example 2

A timepiece part (dials) was manufactured in the same manner as in Example 1 except for the fact that a base material constituted of stainless steel was used as the base material, and the second region and the third region were not formed.

### Comparative Example 3

A disc-shaped Au member was produced by means of casting, then, necessary places were cut and polished, and a dial (timepiece part) having dimensions of a diameter of approximately 27 mm and a thickness of approximately 0.5 mm was obtained. That is, the timepiece part of the present comparative example was constituted of a solid gold material.

The constitutions of the timepiece parts of the examples and the comparative examples are summarized in Table 1. The thicknesses of the respective portions except for the base materials are given in parentheses. In addition, in the table, PC represents polycarbonate, G represents inorganic glass, and SUS represents stainless steel. In addition, in the respective portions constituting the timepiece parts, the content ratios of the components shown in the table are all 99.9% by mass or more.

In addition, in all of the respective examples having a layer constituted of TiC, the content ratio of carbon (C) in the corresponding layer was a numerical value in a range of 50% by mass or more and 60% by mass or less.

In addition, in all of the respective examples having a layer constituted of TiN, the content ratio of nitrogen (N) in the corresponding layer was a numerical value in a range of 50% by mass or more and 60% by mass or less.

In addition, in all of the respective examples having a layer constituted of TiCN, the content ratio of carbon (C) in the corresponding layer was a numerical value in a range of 5% by mass or more and 15% by mass or less, and the content ratio of nitrogen (N) in the corresponding layer was a numerical value in a range of 1% by mass or more and 5% by mass or less.

TABLE 1

| | |
|---|---|
| Example 1 | Al (base material)/SiO₂ (131 nm)/Al (6 nm)/TiO₂ (22 nm)/SiO₂ (113 nm)/ |
| | TiO₂ (40 nm)/SiO₂ (50 nm)/TiO₂ (27 nm) |
| Example 2 | PC (base material)/TiN (100 nm)/SiO₂ (124 nm)/TiN (80 nm)/SiO₂ (66 |
| | nm)/Ta₂O₅ (68 nm)/SiO₂ (135 nm)/Ta₂O₅ (84 nm) |
| Example 3 | PC (base material)/Ti (72 nm)/SiO₂ (45 nm)/Ti (8 nm)/TiO₂ (50 nm)/SiO₂ |
| | (80 nm)/TiO₂ (38 nm)/SiO₂ (60 nm)/TiO₂ (40 nm)/SiO₂ (150 nm) |
| Example 4 | G (base material)/TiO₂ (36 nm)/SiO₂ (50 nm)/TiO₂ (45 nm)/SiO₂ (78 nm)/ |
| | TiO₂ (70 nm)/Ti (19 nm)/SiO₂ (135 nm)/Ti (32 nm) |
| Example 5 | Al (base material)/SiO₂ (130 nm)/Al (6 nm)/Nb₂O₅ (22 nm)/SiO₂ (114 |
| | nm)/Nb₂O₅ (38 nm)/SiO₂ (53 nm)/Nb₂O₅ (25 nm) |
| Example 6 | Al (base material)/SiO₂ (138 nm)/Al (6 nm)/ZrO₂ (23 nm)/SiO₂ (125 nm)/ |
| | ZrO₂ (37 nm)/SiO₂ (56 nm)/ZrO₂ (30 nm) |
| Example 7 | SUS (base material)/TiCN (150 nm)/SiO₂ (205 nm)/TiCN (80 nm)/ZrO₂ |
| | (120 nm)/SiO₂ (77 nm) |
| Example 8 | SUS (base material)/TiCN (150 nm)/SiO₂ (280 nm)/TiCN (60 nm)/Al₂O₃ |
| | (107 nm)/SiO₂ (80 nm) |
| Example 9 | SUS (base material)/CrN (55 nm)/SiO₂ (11 nm)/CrN (6 nm)/SiO₂ (108 |
| | nm)/TiO₂ (57 nm)/SiO₂ (120 nm)/TiO₂ (65 nm)/HfO₂ (45 nm) |
| Example 10 | SUS (base material)/TiC (150 nm)/SiO₂ (48 nm)/TiC (37 nm)/TiO₂ (68 |
| | nm)/SiO₂ (106 nm) |
| Example 11 | PC (base material)/CrC (55 nm)/SiO₂ (13 nm)/Cr (6 nm)/SiO₂ (107 nm)/ |
| | TiO₂ (56 nm)/SiO₂ (120 nm)/TiO₂ (43 nm)/HfO₂ (45 nm) |
| Example 12 | PC (base material)/CrCN (55 nm)/SiO₂ (11 nm)/Cr (6 nm)/SiO₂ (108 nm)/ |
| | TiO₂ (57 nm)/SiO₂ (120 nm)/TiO₂ (65 nm)/SiO₂ (60 nm) |
| Comparative | Al (base material)/SiO₂ (135 nm)/Al (20 nm) |
| Example 1 | |
| Comparative | SUS (base material)/TiO₂ (50 nm)/SiO₂ (103 nm)/TiO₂ (61 nm)/SiO₂ (40 |
| Example 2 | nm)/TiO₂ (30 nm)/SiO₂ (87 nm)/TiO₂ (116 nm)/SiO₂ (76 nm) |
| Comparative | Au (base material) |
| Example 3 | |

### [2] Evaluation

The respective timepiece parts manufactured in the respective examples and the respective comparative examples were visually observed.

As a result, all of the timepiece parts of the respective examples exhibited an excellent appearance filled with a luxurious feeling. In particular, the timepiece parts of Examples 2, 9, 11, and 12, similar to Comparative Example 2, exhibited a gold color having a luxurious feeling, and, in Examples 1, 3, 4, 5, and 6, excellent appearances exhibiting bluish luster having a luxurious feeling were obtained. In addition, in the timepiece parts of Examples 7 and 8 in which the first region and the second region were constituted of a carbonitride of Ti and a carbonitride of Cr, appearances having a luxurious feeling similar to pink gold were obtained. In addition, in the timepiece part of Example 10, a bluish black appearance was obtained. In addition, in the timepiece parts of the respective examples, the angle dependency of the appearance of the timepiece part was small, and stably excellent aestheticity was obtained at broad view angles. In addition, when a standard light source D50 was used, in Example 1, L* was 53.0, was 16.9, and b* was −68.7; in Example 2, L* was 85.1, a* was 9.7, and b* was 40.8; in Example 3, L* was 34.3, a* was 42.1, and b* was −95.7; in Example 4, L* was 30.4, a* was 55.4, and b* was −103.3; in Example 5, L* was 52.7, a* was 18.0, and b* was −69.0; in Example 6, L* was 53.7, a* was 17.7, and b* was −68.2; in Example 7, L* was 84.9, a* was 11.6, and b* was 22.6; in Example 8, L* was 85.0, was 11.9, and b* was 24.8; in Example 9, L* was 88.2, was 10.4, and b* was 36.8; in Example 10, L* was 25.0, was −4.3, and b* was −43.6; in Example 11, L* was 88.2, a* was 10.4, and b* was 36.8; in Example 12, L* was 87.7, was 8.5, and b* was 38.1.

In contrast, in Comparative Example 1, only an appearance having a poor luxurious feeling was obtained. In Comparative Example 2, compared with Comparative Example 1, an improvement of the aestheticity was admitted, but the angle dependency of the appearance of the timepiece part was great, the aestheticity degraded when the observation direction was not within a narrow angular range, and stably excellent aestheticity was not obtained. In addition, in Comparative Example 3, an excellent appearance was exhibited, but a large amount of noble metal was required to manufacture the timepiece part.

For Examples 1 to 3 and 5 to 12, the observation was carried out from the surface on the side opposite to the base material, and, in Example 4, the observation was carried out from the surface on the base material side.

Timepiece parts (cases and bands) were manufactured in the same manner as in the respective examples and the respective comparative examples except for the fact that the shapes of the base materials were changed to a case or a band, and the same evaluation as described above was carried out. As a result, the same results as described above were obtained.

In addition, timepiece parts (cases and bands) were manufactured in the same manner as in Examples 1, 5, and 6 except for the fact that Cr was used instead of Al as the material for the first region and the second region, and the same evaluation as described above was carried out. As a result, the same results as described above were obtained.

In addition, wristwatches as shown in FIG. 4 were assembled using the timepiece parts manufactured in the respective examples and the respective comparative examples. The same evaluation as described was carried out on these wristwatches, and consequently, the same results as described above were obtained.

The entire disclosure of Japanese Patent Application Nos. 2017-014556, filed Jan. 30, 2017 and 2017-216499, filed Nov. 9, 2017 are expressly incorporated by reference herein.

What is claimed is:

1. A timepiece part comprising:
a metallic luster portion which has a first region constituted of a first material including a nitride or carbide of Ti, a nitride or carbide of Cr, or a metallic material, a film-like second region constituted of a second material including a nitride or carbide of Ti, a nitride or carbide of Cr, or a metallic material, and a film-like third region which is provided between the first region and the second region and is constituted of a light transmissive material and which exhibits metallic luster; and
a tone film which is provided on the second region side of the metallic luster portion, is constituted of a multilayer film of a metallic oxide, and has a function of adjusting tone.

2. The timepiece part according to claim 1,
wherein the first region is a base material constituted of the first material.

3. The timepiece part according to claim 1,
wherein the first region is a coating provided on a base material constituted of a material not substantially including any of a nitride and a carbide of Ti, a nitride and a carbide of Cr, and a metallic material.

4. The timepiece part according to claim 1,
wherein the first region has a thickness of 10 nm or more.

5. The timepiece part according to claim 1,
wherein the second region has a thickness of 200 nm or less.

6. The timepiece part according to claim 1,
wherein the third region is constituted of a metallic oxide.

7. The timepiece part according to claim 1,
wherein the third region has a thickness of 10 nm or more.

8. The timepiece part according to claim 1,
wherein the tone film has a layer constituted of a material including at least one compound selected from the group consisting of Ta₂O₅, SiO₂, TiO₂, Al₂O₃, ZrO₂, Nb₂O₅, and HfO₂.

9. The timepiece part according to claim 1,
wherein a thickness of the tone film is preferably 100 nm or more and 2,000 nm or less.

10. The timepiece part according to claim 1,
wherein the second region is constituted of a material including Ti, Cr, or Al.

11. The timepiece part according to claim 1,
wherein the timepiece part is windshield glass, a dial, a case, or a band.

12. A timepiece comprising:
the timepiece part according to claim 1.

13. A timepiece comprising:
the timepiece part according to claim 2.

14. A timepiece comprising:
the timepiece part according to claim 3.

15. A timepiece comprising:
the timepiece part according to claim 4.

16. A timepiece comprising:
the timepiece part according to claim 5.

17. A timepiece comprising:
the timepiece part according to claim 6.

18. A timepiece comprising:
the timepiece part according to claim 7.

19. A timepiece comprising:
the timepiece part according to claim 8.

20. A timepiece comprising:
the timepiece part according to claim 9.
